(19) United States
(12) Patent Application Publication
(10) Pub. No.: US 2005/0053044 A1
(43) Pub. Date: Mar. 10, 2005

(54) Packet transmission in an adaptive antenna system

(76) Inventors: Martin Alm, Molndal (SE); Stephen Craig, Stockholm (SE)

Correspondence Address: NIXON & VANDERHYE, PC, 1100 N GLEBE ROAD, 8TH FLOOR, ARLINGTON, VA, 22201-4714, US

(21) Appl. No.: 10/658,756

(22) Filed: Sep. 10, 2003

(51) Int. Cl. H04Q 7/24

(52) U.S. Cl. 370/338

(57) ABSTRACT

A method and apparatus for use in a radio network that employs adaptive antennas. If an amount of uplink information to be transmitted is less than a predetermined value, the mobile is sent a permission to transmit a first amount of information. Otherwise, the mobile is sent permission to transmit a second larger amount to reduce a number of times a permission to transmit message must be sent to the mobile. When two pieces of information with different amounts of coding are packed in the same data block and are intended for two different antenna beams, the beam pointing in the direction of the mobile station with the least coding should be used for the transmission.

### BACKGROUND AND SUMMARY OF THE INVENTION

The present invention relates to packet transmission in an adaptive antenna system, and more particularly, resolves certain antenna beam transmission issues that arise when both data and signaling information need to be transmitted to multiple mobile stations.

It is anticipated that a large part of the future growth of wireless communications will be data traffic. Due to the “burstiness” of data traffic, the frequency spectrum is more effectively used if the mobile wireless users share a common radio communications resource. Packet data accomplishes this by multiplexing several users on the same radio resource. General Packet Radio Services (GPRS), enhanced GPRS (EGPRS), and Wideband Code Division Multiple Access (WCDMA) are non-limiting examples of mobile communications systems that provide packet data communications over the radio interface. For ease of description and not limitation, the following description employs EGPRS as an example context in which the present application may be employed. In EGPRS, a mobile station may be assigned several time slots if capacity is available. Of course, the invention may be employed in other contexts and in other communications systems.

EGPRS/GPRS supports both connection-less protocols (e.g., IP) and connection-oriented protocols (e.g., X.25). An advantage with a packet-switched data communication protocol is that a single transmission resource can be shared between a number of users. In the case of the well-known GSM cellular network, a timeslot on a radio frequency carrier can be utilized by several mobile users for reception and transmission of data. The radio network manages the shared transmission resources for both base station and mobile station transmissions.

The radio network controls packet data scheduling in both the downlink (network-to-mobile) and the uplink (mobile-to-network). One way to dynamically schedule uplink resources is to send a signaling message over the downlink instructing a mobile when to transmit over the uplink. FIGS. 1A and 1B help illustrate a possible uplink collision situation. FIG. 1A shows a base station and a cell in which two spatially separated mobiles are located. The mobiles are multiplexed on the same timeslot number (TN1) in the downlink direction (i.e., they alternately receive on the timeslot). In this example, the base station transmits information addressed for mobile MS2. Mobile MS1 will also receive the message but will not store it since it is not intended for mobile MS1. FIG. 1B shows the two mobiles assigned to the same timeslot number (TN1) on the uplink as well. Both mobiles are trying to transmit to the base station, but since both mobiles transmit simultaneously on the same timeslot, it will be difficult for the base station to decode the messages. FIG. 1C shows sending a signaling message to both mobiles (a USF message in this example) indicating that mobile MS2 has permission to use the same timeslot TN on the uplink to transmit as the timeslot TN on which it received the signaling message. Mobile MS1 also decodes the signaling messages but is not allowed to transmit since the message was not addressed to mobile MS1.

To share transmission resources between a number of mobile users in EGPRS, the network uses temporary flow identifiers (TFIs) and uplink state flags (USFs). Similar signaling messages may be employed in other systems that support packet communications. At the start of a transmission, a mobile is assigned one or more time slots in the uplink and/or downlink. The mobile is also assigned a TFI and USF. One USF is assigned for each timeslot that the mobile is allocated on the downlink. The TFI is attached to downlink radio link control (RLC)/medium access control (MAC) blocks to indicate the destination of each RLC/MAC block. Mobiles listen to the assigned time slots in the downlink and try to decode all radio blocks transmitted on the downlink. After decoding a received block, a mobile checks the TFI for that block to determine if the mobile is the destination of that block. While attempting to decode the blocks transmitted on the downlink, the mobile also determines whether it is allowed to transmit on the uplink as indicated by the USF. For efficiency, the relatively short USF signaling message is included in the header of the RLC/MAC block and transmitted together with the payload data message in a single downlink packet.

An antenna system which can change its characteristics in response to changes in the network is an adaptive antenna system. One important feature of an adaptive antenna system is detecting the direction or location of mobile stations. With that information, dedicated information may be transmitted in a narrow antenna beam directed towards an individual mobile station. An antenna beam is any signal transmission deliberately covering only a part of a cell. A cell is a base station coverage area. By directing the signal towards its recipient, the interference in that cell and in neighboring cells can be substantially reduced. This advantage is illustrated in FIG. 2. Adaptive antennas and packet data are a very attractive combination for increasing the data capacity in a cellular radio communications network.

A problem with adaptive antennas is encountered if information for spatially-separated mobile stations covered by different antenna beams needs to be transmitted simultaneously. This situation is referred to as a “beam conflict.” Since adaptive antennas use narrow beams which only cover part of a cell, the transmitted signal can only be optimized for one of the mobile stations if they are not located in areas covered by the same beam. Beam conflicts may occur in EGPRS, for example, where the USF and user payload data intended for mobiles in different beams are combined in the same data block or packet.

One solution to this problem is to use a sector antenna to transmit all data traffic. An adaptive antenna beam conflict is shown in FIG. 3A. The sector antenna solution shown in FIG. 3B transmits to all mobiles in the cell and thus avoids retransmissions that might otherwise be required as a result of beam conflicts like those in FIG. 3A. But the large gains with adaptive antennas are lost, i.e., the interference in the network is increased and the throughput thereby decreased.

A second solution is to multiplex mobile stations located in the same beam-sector on the same timeslot and frequency. A beam-sector is the cell area covered by a narrow antenna beam. Since many mobile stations have the ability to transmit and receive over multiple time slots, it will be difficult to multiplex mobile stations located in the same beam-sector on the same timeslot and frequency. One extreme example that illustrates this drawback is five, 3-slot mobile stations located in different beam-sectors which are assigned on 8 packet data channels in the downlink. If the mobiles can only be assigned to channels where mobiles located in the same beam resided, the system would quickly run out of timeslots. On mobile may be assigned less than 3 timeslots and another mobile perhaps no timeslots since they otherwise would be assigned on channels used by mobiles in other beams.

Beam conflict situations may be encountered quite frequently in systems where the radio network must grant mobiles permission to transmit in the uplink direction to the network. The USF is one example of such transmission permission message that must be sent regularly. Being relatively short, such messages are typically included in the header of RLC/MAC blocks. In EGPRS, there are two different options for a “granularity” of the USF. A “granularity” of 1 means that one received USF gives a mobile permission to transmit one radio block. Another USF must be received before the next radio block can be transmitted. That granularity is static for that TBF. Since many USFs are generated with a granularity of one, the number of beam conflict situations may be quite high.

The present invention overcomes these problems associated with beam conflicts. In a radio network that employs multiple antennas, an amount of information to be transmitted in an uplink direction by a mobile station to the radio network is determined. If the amount of uplink information is less than a predetermined value, a permission to transmit a first amount of information is sent to the mobile. If the amount of uplink information is equal to or exceeds the predetermined value, permission to transmit a second amount of information greater than the first amount is sent to the mobile. The permission to transmit may be a flag, and in an example EGPRS application, may be an uplink state flag (USF).

If the amount of uplink information is less than the predetermined value, a lower USF granularity is sent to the mobile station, and if the amount of uplink information is equal to or exceeds the predetermined value, a higher USF granularity is sent to the mobile station. In one EGPRS example, the lower USF granularity is a granularity of one USF per one radio block to be transmitted uplink, and the higher USF granularity is a granularity of one USF per four radio blocks to be transmitted uplink. So USFs for short uplink data amounts use a granularity of 1, but a granularity of 4 is sent for longer uplink data amounts. In the latter case, four uplink radio blocks of data can be transmitted based on receipt of one USF with granularity 4. The number of data block assemblies with the potential for beam conflicts could be reduced by as much as 75%.

Another aspect of the present invention may be used alone, but it is preferably used together with the adaptive granularity featured described above. First information having a first amount or level of coding, such as FEC (Forward Error Correction), is to be transmitted in a downlink direction to a first mobile station associated with a first antenna beam. Second information having less coding than the first information is to be transmitted to a second mobile station associated with a second antenna beam. The first information and second information are combined in a data block. The data block is transmitted in the second antenna beam. The first information, being more extensively coded, is reasonably likely to be accurately decoded at the first mobile station even though it is transmitted on the second antenna beam rather than the first antenna beam. Again, in one example application, the first information is a permission to transmit in the uplink and the second information is payload data.

In a downlink packet data scheduling context, the first information for plural mobile stations can be stored in a first buffer, and the second information for plural mobile stations can be stored in a second buffer. An antenna beam associated with each mobile station is determined. If possible, the first and second information for one mobile station is combined into a data block and sent to the one mobile station using its associated antenna beam. Also if possible, first information and second information for different mobile stations associated with a same antenna beam are identified, combined, and sent to the different mobile stations using the same antenna beam.

In another, less-preferred, alternative embodiment for dealing with beam conflict situations, the first information associated with a first mobile and first antenna beam is combined with “dummy” second information into a first data unit. The first data unit is transmitted to the first mobile station using the first antenna beam. Similarly, the second information may be combined with “dummy” first information into a second data unit. The second data unit associated with a second mobile and second antenna beam is transmitted to the second mobile station using the second antenna beam.

The present invention is particularly useful in high traffic load situations. In these situations, achieving maximum interference reduction through optimal adaptive antenna performance is particularly important. By minimizing beam conflict situations and handling beam conflicts efficiently, the present invention achieves excellent adaptive antenna performance.

### BRIEF DESCRIPTION OF THE DRAWINGS

Various objects and advantages of the invention will be understood by reading the detailed description in conjunction with the drawings in which:

FIG. 1A shows a base station in which coverage area two mobiles have been multiplexed on the same downlink timeslot (TN1);

FIG. 1B shows both mobiles trying to transmit on uplink simultaneously on the same TN back to the base station resulting in a potential collision;

FIG. 1C illustrates sending a USF addressed to mobile MS2 giving it permission to transmit on the uplink;

FIG. 2 illustrates an adaptive antenna;

FIG. 3A illustrates the problem of a beam conflict situation when using an adaptive antenna;

FIG. 3B illustrates a solution to the beam conflict using a sector antenna;

FIG. 4 illustrates communication system in which an example embodiment may be advantageously employed.

FIG. 5A illustrates an example, simplified downlink packet for transmission from the radio network to a mobile station;

FIG. 5B illustrates a simplified RLC/MAC downlink radio packet for use in an EGPRS-based communication system;

FIG. 6 illustrates a probability that USF (MCS5-9 USF), MCS1, or MSC9 data is falsely decoded as a function of the carrier-to-interference ratio (C/I) measured in dB;

FIG. 7 illustrates a relative, mean, circuit-switched, equivalent bit rate (CSEBR) for two different beam conflict resolution approaches compared to an ideal adaptive antenna mean user bit rate;

FIG. 8 illustrates a beam conflict mitigation routine in accordance with a non-limiting, example embodiment; and

FIG. 9 illustrates a relative, mean, CSEBR for two different beam conflict resolution approaches compared to an ideal adaptive antenna mean user bit rate;

FIG. 10 illustrates beam conflict mitigation in accordance with another, non-limiting, example embodiment.

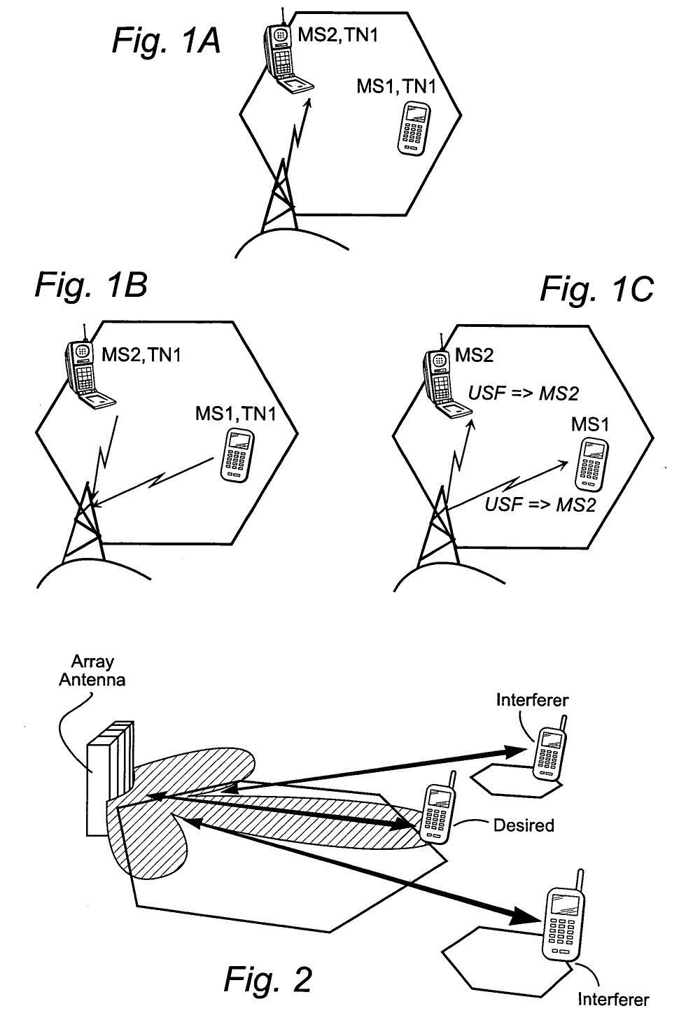

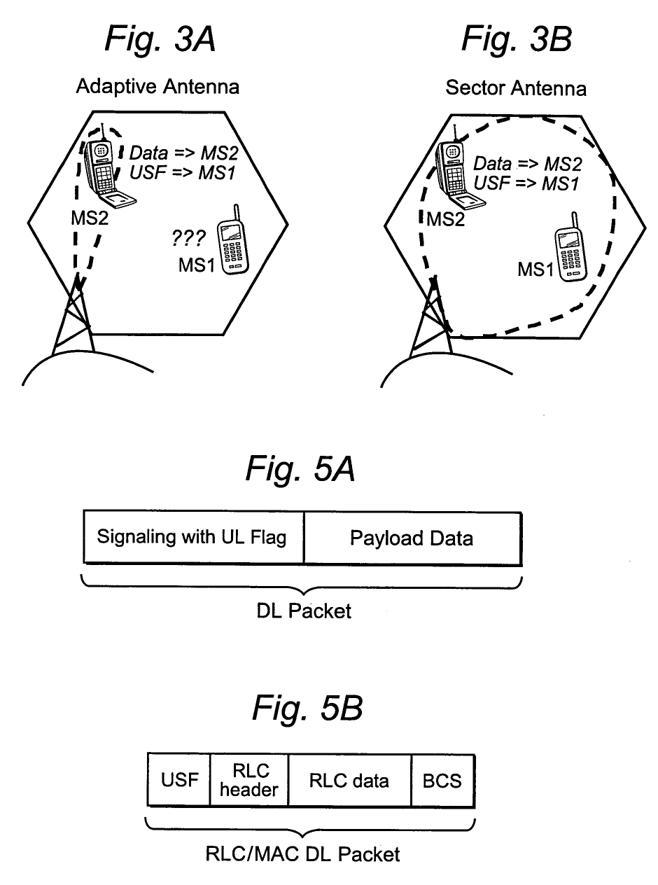

### DETAILED DESCRIPTION

The present invention is directed to data transmission networks which implement adaptive antennas and in the following description, for purposes of explanation and not limitation, specific details are set forth in order to provide a thorough understanding of the present invention. But it will be apparent to one skilled in the art that the present invention may be practiced using other embodiments that depart from these specific details. In other instances, detailed descriptions of well-known methods, protocols, devices, and circuits are omitted so it is not to obscure the description of the present invention.

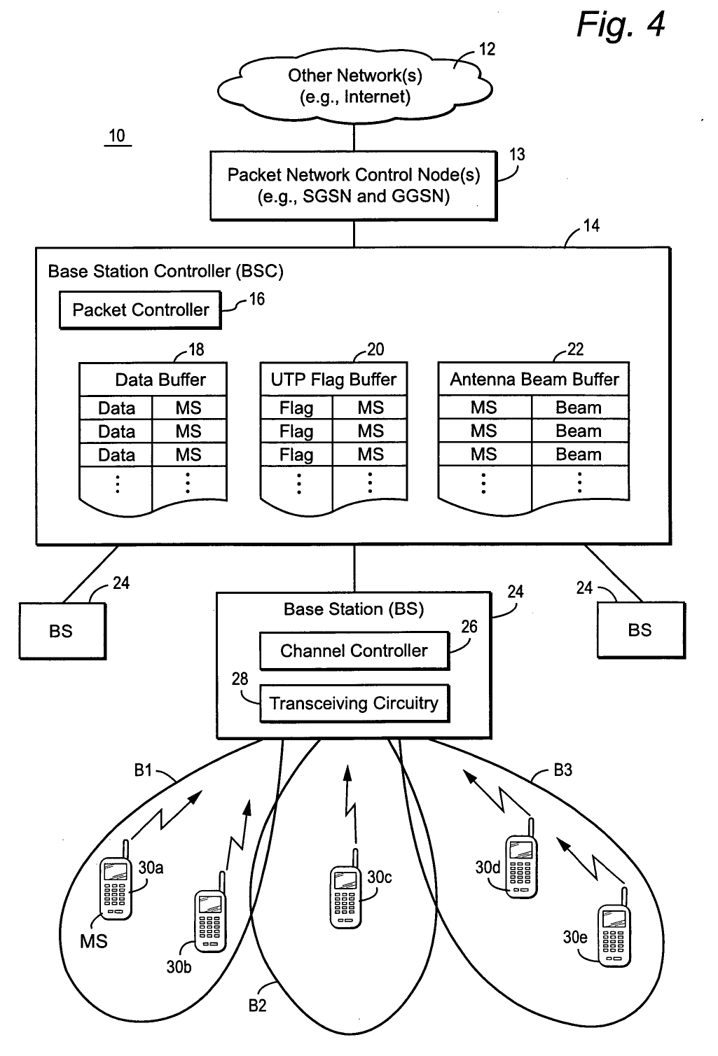

FIG. 4 illustrates a communication system 10 in which the present invention may be advantageously employed. One or more networks, such as the Internet, represented by a cloud 12 is (are) coupled to one or more packet network control nodes 13, e.g., an SGSN and a GGSN in the well-known GPRS network. The packet network control 13 is coupled to a base station controller (BSC) 14, which in turn, is coupled to one or more base stations (BS) 24. One of the base stations 24 includes an adaptive antenna system illustrated by three adaptive, narrow antenna beams B1, B2, and B3. The adaptive antenna system (e.g., an adaptive antenna array) is coupled to transceiving circuitry 28 in the base station 24. The channel controller 26 controls the transceiving circuitry and selection/activation of a particular antenna beam. The selection of information to be transmitted over a particular beam is performed in this example by a control unit in the the BSC 14, i.e., RLC/MAC blocks are constructed by that control unit and forwarded to the base station. Various mobile stations (MS) 30a-30e are shown in various antenna beams B1, B2, and B3.

The base station controller (BSC) 14 includes a packet controller 16 and three representative buffers including a transmit data buffer 18, an uplink transmit permission (UTP) flag buffer 20, and an antenna beam buffer 22. Data buffer 18 includes payload data to be transmitted via a base station to one of the mobile stations. Each payload data unit is associated with a mobile station identifier represented in the buffer as “MS.” The UTP flag buffer 20 includes a particular UTP flag and identifying information associated with a particular mobile station. A UTP flag indicates that a mobile station has permission to transmit in the uplink. In the EGPRS context, the UTP flag is a USF which gives the mobile station associated with the USF permission to transmit on the same timeslot number on the uplink as it received the USF on the downlink. The antenna beam buffer 22 is generated by the base station controller 14 using information received from the base station 24 about the location of each mobile station and the particular antenna beam that covers or is closest to each mobile station.

FIG. 5A illustrates a simplified downlink, data block or packet. A signaling field includes UTP information such as a UTP flag intended for a particular mobile station. The payload includes data intended for a particular mobile station. FIG. 5B illustrates a particular example: a simplified downlink, radio link control (RLC)/medium access control (MAC) packet for use in an example EGPRS system. A signaling field includes a USF along with an RLC header. The payload includes RLC data intended for a particular mobile station along with a Block Code Sequence (BCS) used for error detection.

The packet controller 16 also controls the granularity associated with each uplink transmit permission (UTP) flag in UTP buffer 20. Granularity for the UTP flag is determined based upon the amount of data to be transmitted by the mobile station in the upward direction. For smaller amounts of data, the packet controller 16 assigns a granularity of one. When the mobile station receives the USF with granularity 1, it has permission to transmit a single radio block. An example situation in which granularity 1 might be appropriate is when the mobile station intends to transmit a TCP packet acknowledgement message or an initial request to download objects. Setting a larger granularity for small amounts of information is not efficient since multiple uplink radio blocks will be empty. For larger amounts of data to be sent in the uplink direction from the mobile, the packet controller 16 assigns a larger granularity. This permits the mobile station to transmit multiple consecutive radio blocks after receiving just a single USF, the exact number being determined by the granularity value. It is likely in many applications, such as sending an email message, that multiple uplink radio blocks will be filled completely with data, making a larger granularity more efficient.

Consider the EGPRS example where the USF's are sent with granularities of 1 and 4. For larger amounts of data, the number of USF's that must be sent per radio block is reduced dramatically—by 75%. As a result, the number of beam conflicts scenarios is reduced. In other words, beam conflicts created by having a USF intended for one mobile station and payload data intended for another mobile station located in a different antenna beam are reduced by reducing the number of USF's that must be transmitted in a downlink direction.

But there still needs to be an appropriate methodology for handling beam conflicts when they do occur. A preferred approach for handling beam conflicts is now described. A data block containing a UTP flag intended for first mobile and payload data intended for a second mobile located at a different antenna beam is transmitted in the antenna beam directed to the data mobile; i.e., the second mobile in this case. The data mobile antenna beam is selected because the UTP coding is usually more robust than payload data coding.

In EGPRS, the USF has a code rate of 1/12, whereas the most robust coding scheme for data, corresponding to modulation coding scheme (MSC)1, has a code rate of 0.53. Every USF bit becomes 12 bits after coding, and every data bit becomes about two bits after coding. The much larger redundancy in the USF coding means that the USF mobile has a very high probability of accurately decoding the USF, even though it is not transmitted in the USF's associated antenna beam.

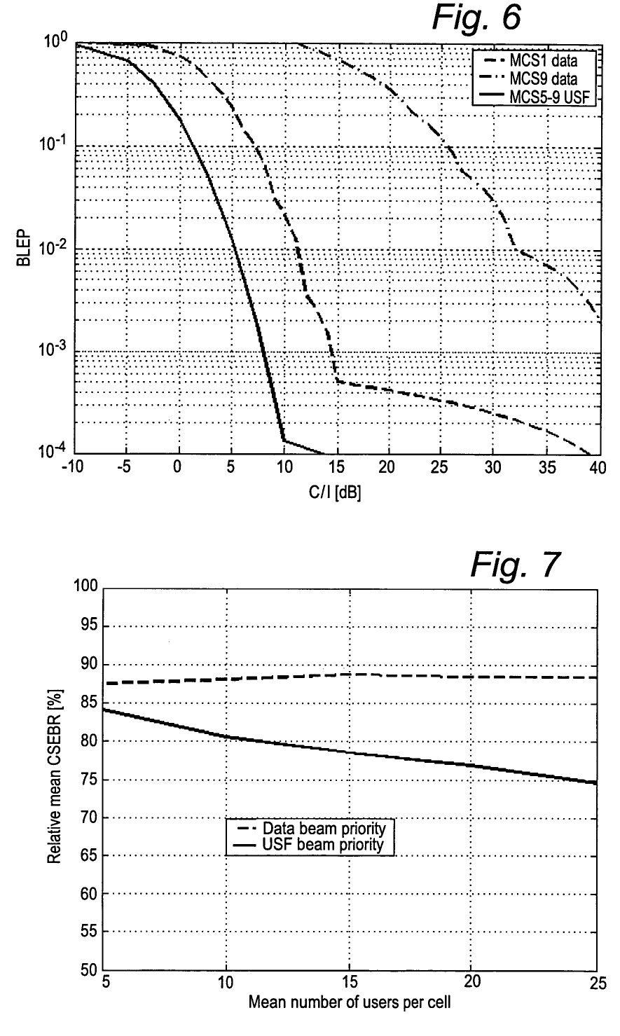

FIG. 6 illustrates simulation results that show the probability of the USF (shown as MCS5-9 USF), MCS1 data (most robust data coding), and MCS9 data (least robust coding) being falsely decoded as a function of the carrier-to-interference ratio (C/I) measured in dB. The USF decoding performance is much better than even the most robust payload data coding scheme MSC1. For example, for a carrier-to-interference ratio of 5 dB, the probability that the USF is falsely decoded is 1%; whereas it is 20% for MSC1 data and 100% for MSC9 data.

The negative consequences of a falsely-decoded USF are also less severe than those for falsely-decoded payload data. If the USF is not decoded by the mobile, the radio network knows immediately since it will not receive a radio block on the uplink from that mobile at the permitted/designated time slot. The radio network can then send another USF to the mobile immediately or as soon as can be scheduled. On the other hand, if payload data is unsuccessfully decoded by the mobile, the radio network will not know until it receives a NACK report which introduces extra delay.

FIG. 7 illustrates results from a simulation that show that the mobile station's data throughput is higher when the payload data transmission is prioritized by selecting the payload data mobile's antenna beam, rather than prioritizing the USF by selecting the USF mobile's antenna beam. The mean, circuit-switched, equivalent bit rate (CSEBR) for both USF beam priority and payload data beam priority scenarios are compared to the ideal adaptive antenna mean CSEBR for different traffic loads (mean numbers of users per cell). The dashed line corresponding to the prioritized data beam always exceeds (higher performance) the solid line when the USF is prioritized. Additionally, the performance difference between the two methods increases as the traffic increases. Adaptive antennas give the largest performance gain relative to sector antennas when the traffic load is high.

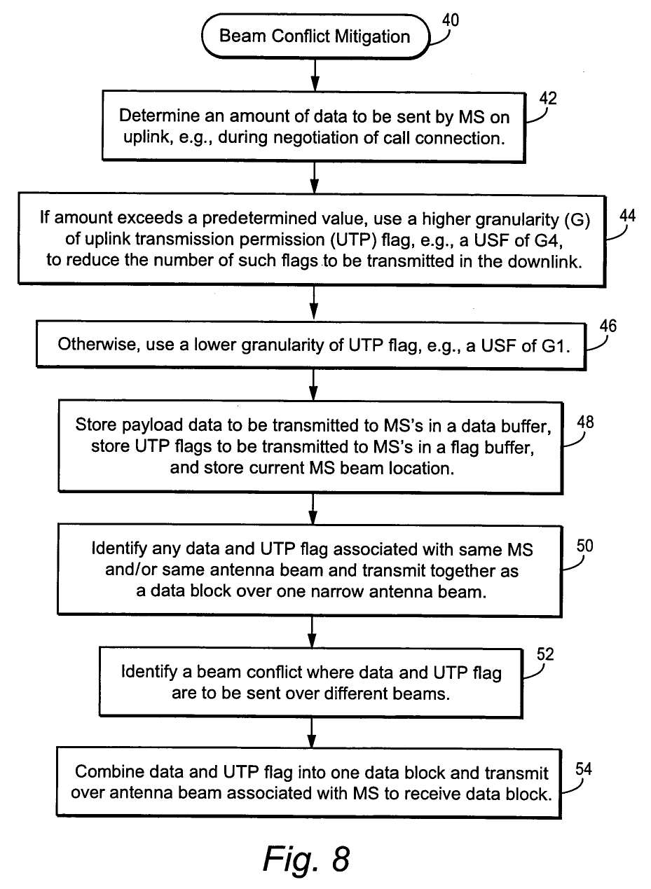

Example procedures for implementing a beam conflict mitigation procedure in accordance with a preferred, non-limiting, example embodiment is now shown in the beam-conflict litigation flowchart (block 40) of FIG. 8. Because it is preferred to reduce the number of UTP messages, blocks 42, 44, and 46 which relate to the first aspect of the invention, are included in these procedures. An amount of data to be sent by the mobile station on the uplink is determined, e.g., during the initial call connection set up negotiations (block 42). If the amount of data to be sent exceeds a predetermined value, a higher granularity (G) for sending uplink transmission permission (UTP) flags is employed to reduce the number of such flags transmitted in the downlink (block 44). In the above-described EGPRS example, that higher USF granularity was G4. Otherwise, a lower granularity for sending UTP flags is used (block 46). In the above-described EGPRS example, that lower USF granularity was G1.

Payload data to be transmitted to mobile stations in a base station cell are stored in a data buffer; UTP flags to be transmitted to mobile stations are stored in a flag buffer; and each mobile station's current antenna beam location is determined (block 48). A data payload and a UTP flag associated with the same mobile station and/or same antenna beam are grouped together as a data block and transmitted over one narrow antenna beam (block 50). A beam conflict is identified when the payload data and the UTP flag to be combined are to be sent over different beams (block 52). In that case, the payload data and the UTP flag are combined into a data block and transmitted via the antenna beam associated with the mobile station that is to receive the data block, e.g., “data mobile” receives “priority” (block 54).

While the data antenna beam selection is the preferred approach to resolving beam conflicts situations, another example embodiment also solves this problem but at lower performance. If no data is available, the USF is transmitted with a “dummy” block of payload data. A dummy block does not contain any real payload. It may be used to transmit the USF in cases when there is no payload data available, but it may also be used to transmit the USF whenever there is a beam conflict. Thus, in a beam conflict scenario, the USF may be sent with a dummy block of payload data that will be ignored by mobile stations, and the payload data may be sent with a dummy USF that will be ignored by mobile stations. In that case, the “dummy” USF would be realized by setting the USF to a value not used by any mobile station.

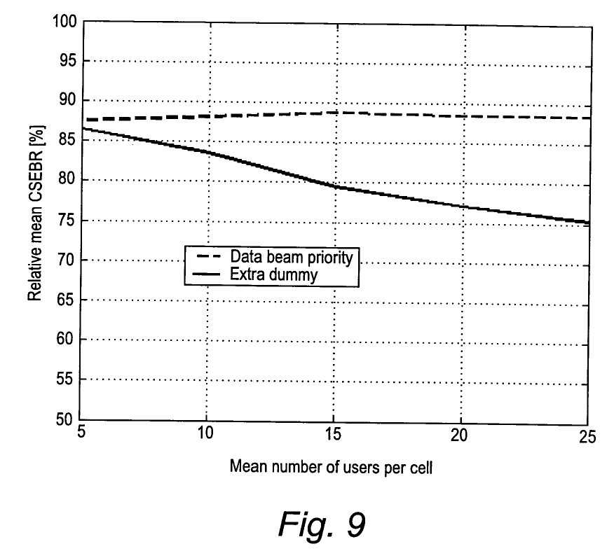

As shown in the FIG. 9 graph, this dummy block approach is less desirable because its performance, although slightly better than a USF mobile beam priority approach, is lower than the data mobile beam priority approach. This because the dummy block generates interference without carrying useful payload data. Nonetheless, the dummy block approach provides reasonable performance and may be used in certain situations if desired.

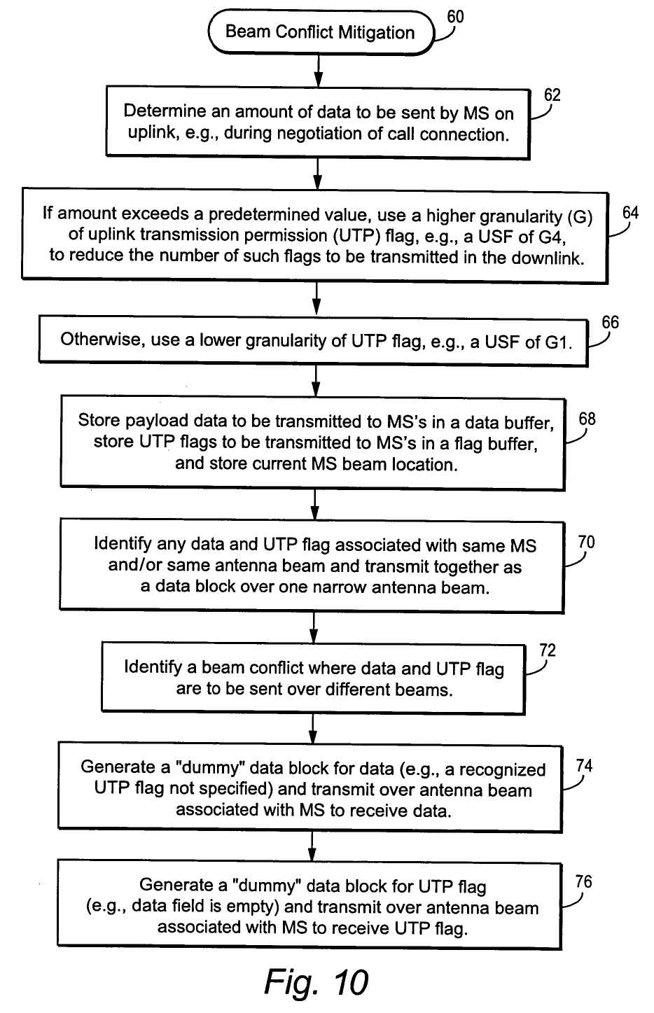

Example procedures for implementing beam conflict mitigation in accordance with the dummy block embodiment are now shown in the beam-conflict litigation flowchart (60) of FIG. 10. Because it is preferred to reduce the number of UTP messages, blocks 62, 64, and 66 which relate to the first aspect of the invention are included in these procedures. An amount of data to be sent by the mobile station on the uplink is determined, e.g., during the negotiations of the call connection (block 62). If the amount of data to be sent exceeds a predetermined value, a higher granularity (G) for sending uplink transmission permission (UTP) flags is employed to reduce the number of such flags transmitted in the downlink (block 64). In the above-described EGPRS example, that higher USF granularity was G4. Otherwise, a lower granularity for sending UTP flags is used (block 66). In the above-described EGPRS example, the lower USF granularity was G1.

Payload data to be transmitted to mobile stations in a base station cell are stored in a data buffer; UTP flags to be transmitted to mobile stations are stored in a flag buffer; and each mobile station's current antenna beam location is determined (block 68). A data payload and a UTP flag associated with the same mobile station and/or same antenna beam are grouped together as a data block and transmitted over one narrow antenna beam (block 70). A beam conflict is identified when the payload data and the UTP flag to be combined are to be sent over different beams (block 72). In that case, a data block is generated for the payload data, and “dummy” bit(s) are used for the UTP information. The dummy bits are not recognized as a UTP. The data and dummy UTP bits are combined into a data block and transmitted via the antenna beam associated with the mobile station that is to receive the data block (block 74). Similar procedures may be applied for unmatched UTP's. A radio data block is generated for the UTP, and dummy bits are used for the payload data. The dummy bits are not recognized as data. The UTP and dummy data bits are combined into a data block and transmitted via the antenna beam associated with the mobile station that is to receive the UTP (block 76).

The present invention decreases retransmissions caused by sending information to two mobile stations located in different parts of a cell served by multiple antenna beams. Decreased retransmissions mean increased data throughput and reduced delay. Use of adaptive antennas further decreases interference in other cells. The present invention is particularly useful in high traffic load situations. In these situations, achieving maximum interference reduction through optimal adaptive antenna performance is particularly important. Although well-suited for GPRS and EGPRS based systems, the present invention may be employed in any other cellular system where information is to be sent to spacially-separated mobiles using multiple antenna beams. Although the processing and decisions described above took place in the base station controller, they may also be implemented in the base station or in some other node if desired.

The invention has been described in connection with what is presently considered to be the most practical and preferred embodiment. The invention is not to be limited to the disclosed embodiment, but on the contrary, is intended to cover various modifications and equivalent arrangements included within the spirit and scope of the appended claims. For example, the invention may be used with any antenna system where beam conflicts may arise.

1. A method for use in a radio network that employs adaptive antennas, comprising:
for a connection with a first mobile station, determining an amount of information to be transmitted in an uplink direction by the first mobile station to the radio network;
if the amount of uplink information is less than a predetermined value, sending to the first mobile station a permission to transmit a first amount of information; and
if the amount of uplink information is equal to or exceeds the predetermined value, sending to the first mobile station a permission to transmit a second amount of information greater than the first amount to reduce a number of times permission to transmit must be sent to the first mobile station.

2. The method in claim 1, wherein the permission to transmit is a flag.

3. The method in claim 2, wherein the permission to transmit is an uplink state flag (USF).

4. The method in claim 3, wherein if the amount of uplink information is less than the predetermined value, a lower USF granularity is sent to the first mobile station, and if the amount of uplink information is equal to or exceeds the predetermined value, a higher USF granularity is sent to the first mobile station.

5. The method in claim 4, wherein the lower USF granularity is a granularity of one USF per one radio block to be transmitted uplink, and the higher USF granularity is a granularity of one USF per four radio blocks to be transmitted uplink.

6. The method in claim 1, further comprising:
determining whether first information having a first level of coding is to be transmitted in a downlink direction from the radio network to the first mobile station associated with a first antenna beam;
determining whether second information having less coding than the first information is to be transmitted in a downlink direction from the radio network to a second mobile station associated with a second antenna beam;
combining the first and second information in a data block; and
transmitting the data block in the second antenna beam.

7. The method in claim 6, wherein the first information is a permission to transmit in the uplink and the second information is payload data.

8. The method in claim 6, further comprising:
storing the first information for plural mobile stations;
storing the second information for plural mobile stations;
determining an antenna beam associated with each of the mobile stations;
identifying first information and second information for one of the mobile stations; and
sending the first and second information in a data block to the one mobile station using the associated antenna beam.

9. The method in claim 8, further comprising:
identifying first and second information for different mobile stations associated with a same antenna beam, and
sending the first and second information in a data block to the different mobile stations using the same antenna beam.

10. The method in claim 1, further comprising:
determining whether first information is to be transmitted in a downlink direction from the radio network to the first mobile station associated with a first antenna beam;
determining whether second information is to be transmitted in a downlink direction from the radio network to a second mobile station associated with a second antenna beam;
combining the first information with dummy second information into a first data unit; and
sending the first data unit to the first mobile station using the first antenna beam.

11. The method in claim 10, further comprising:
combining the second information with dummy first information into a second data unit; and
sending the second data unit to the second mobile station using the second antenna beam.

12. A method for use in a radio network that employs adaptive antennas, comprising: When two pieces of information, with different amounts of coding, are packet in the same data block and are intended for two different antenna beams, the beam pointing in the direction of the mobile with the least coding should be used for the transmission
determining whether first information with a first amount of coding is to be sent in a downlink direction from the radio network to the first mobile station associated with a first antenna beam;
determining whether a second information with a second amount of coding less than the first amount of coding is to be transmitted in a downlink direction from the radio network to a second mobile station associated with a second antenna beam;
combining the first and the second information in a data block; and
transmitting the data block in the second antenna beam.

13. The method in claim 12, wherein the first information is permission to transmit uplink information and the second information is payload information, the method further comprising:
storing the permission to transmit uplink information for plural mobile stations;
storing the payload information for plural mobile stations;
determining an antenna beam associated with each of the mobile stations;
identifying the permission to transmit and payload information for one of the mobile stations; and
sending the permission to transmit and payload information in a data block to the one mobile station using the associated antenna beam.

14. The method in claim 13, further comprising:
identifying permission to transmit and payload information for different mobile stations associated with a same antenna beam, and
sending the permission to transmit and payload information in a data block to the different mobile stations using the same antenna beam.

15. Apparatus for use in a radio network and configured to communicate with at least one radio base station that employs adaptive antennas, comprising:
a connection controller for establishing a connection with a first mobile station by way of the radio base station;
a data controller configured to perform the following tasks:
determine an amount of information to be transmitted in an uplink direction by the first mobile station to the radio base station;
if the amount of uplink information is less than a predetermined value, generate a message for the first mobile station including a permission to transmit a first amount of information; and
if the amount of uplink information is equal to or exceeds the predetermined value, generate a message for the first mobile station including a permission to transmit a second amount of information greater than the first amount to reduce a number of times a permission to transmit must be sent to the first mobile station.

16. The apparatus in claim 15, wherein the permission to transmit is a flag.

17. The apparatus in claim 16, wherein the permission to transmit is an uplink state flag (USF).

18. The apparatus in claim 17, wherein if the amount of uplink information is less than the predetermined value, the message includes a lower USF granularity, and if the amount of uplink information is equal to or exceeds the predetermined value, the message includes a higher USF granularity.

19. The apparatus in claim 18, wherein the lower USF granularity is a granularity of one USF per one radio block to be transmitted uplink, and the higher USF granularity is a granularity of one USF per four radio blocks to be transmitted uplink.

20. A radio communications system incorporating the apparatus in 15, further comprising the radio network, the radio base station that employs adaptive antennas, and the first mobile station.

21. The apparatus in claim 15, wherein the data controller is further configured to:
determine whether first information having a first level of coding is to be transmitted in a downlink direction from the radio base station to the first mobile station associated with a first antenna beam of the radio base station;
determine whether second information having less coding than the first information is to be transmitted in a downlink direction from the radio base station to a second mobile station associated with a second antenna beam of the radio base station;
combine the first and second information into a data block; and
send the data block transmission to the radio base station for transmission using the second antenna beam.

22. The apparatus in claim 21, wherein the first information is a permission to transmit in the uplink and the second information is payload data.

23. The apparatus in claim 21, further comprising:
a first buffer for storing the first information for plural mobile stations;
a second buffer for storing the second information for plural mobile stations, the data controller being further configured to:
determine an antenna beam associated with each of the mobile stations;
identify first information and second information for one of the mobile stations; and
prepare the first and second information in a data block to be transmitted to the one mobile station using the associated antenna beam.

24. The apparatus in claim 23, the data controller being further configured to:
identify first and second information for different mobile stations associated with a same antenna beam, and
prepare the first and second information in a data block for transmission to the different mobile stations using the same antenna beam.

25. The apparatus in claim 15, wherein the data controller is further configured to:
determine whether first information is to be transmitted in a downlink direction from the radio base station to the first mobile station associated with a first antenna beam of the radio base station;
determine whether second information is to be transmitted in a downlink direction from the radio base station to a second mobile station associated with a second antenna beam of the radio base station;
combine the first information with dummy second information into a first data unit; and
prepare the first data unit to be sent to the first mobile station using the first antenna beam.

26. The apparatus in claim 25, wherein the data controller is further configured to:
combine the second information with dummy first information into a second data unit; and
prepare the second data unit to be sent to the second mobile station using the second antenna beam.

27. A node for use in a radio network that employs adaptive antennas, comprising electronic circuitry configured to:
determine whether first information with a first amount of coding is to be sent in a downlink direction from the radio network to the first mobile station associated with a first antenna beam;
determine whether second information with a second amount of coding less than the first amount of coding is to be transmitted in a downlink direction from the radio network to a second mobile station associated with a second antenna beam;
combine the first information and the second information in a data block; and
assign the data block for transmission in the second antenna beam.

28. The node in claim 27, wherein the first information is permission to transmit uplink information and the second information is payload information, the electronic circuitry being further configured to:
store the permission to transmit uplink information for plural mobile stations;
store the payload information for plural mobile stations;
determine which antenna beam is associated with each of the mobile stations;
identify the permission to transmit and payload information for one of the mobile stations; and
combine the permission to transmit and payload information in a data block for transmission to the one mobile station using the associated antenna beam.

29. The node in claim 27, wherein the first information is permission to transmit uplink information and the second information is payload information, the electronic circuitry being further configured to:
identify permission to transmit and payload information for different ones of the mobile stations associated with a same antenna beam, and
combine the permission to transmit and payload information in a data block for transmission to the different mobile stations using the same antenna beam.

30. A radio communications system incorporating the node in 27, further comprising the radio network, an antenna array for generating the first and second antenna beams, and the first and second mobile stations, wherein the node is a base station control node coupled to or coincident with the radio base station.
